(19) United States
(12) Patent Application Publication
(10) Pub. No.: US 2015/0009152 A1
(43) Pub. Date: Jan. 8, 2015

(54) METHOD OF SHARING APPLICATION AND ELECTRONIC DEVICE USING THE SAME

(71) Applicant: HTC Corporation, Taoyuan County (TW)

(72) Inventors: Tai-Yuan Tang, Taoyuan County (TW); Kai-Feng Chiu, Taoyuan County (TW)

(73) Assignee: HTC Corporation, Taoyuan County (TW)

(21) Appl. No.: 13/935,479

(22) Filed: Jul. 3, 2013

(51) Int. Cl. G09G 5/12; G06F 3/0484; G06F 3/0488; G06F 3/041

(52) U.S. Cl. CPC G09G 5/12; G06F 3/041; G06F 3/0484; G06F 3/0488
USPC 345/173

(57) ABSTRACT

The present disclosure provides a method of sharing a software application from one handheld mobile electronic device to another handheld mobile electronic device and a handheld mobile electronic device using the same method. The method and device performs displaying an image which corresponds to the application on the touch screen, receiving a first touch input on the image, displaying a sharing area of the touch screen in response to a long hold of the first touch input, moving the image to the sharing area according to a moving action of the first touch input, and sharing the application in response to a release action of the first touch input.

### TECHNICAL FIELD

The present disclosure generally relates to a method of sharing a software application from one handheld mobile electronic device to another electronic device and a handheld mobile electronic device using the same method.

### BACKGROUND

A portable handheld electronic device such as a smart phone has become multi-purpose as data processing, personal organizing, entertainment, and communication functions are combined into one portable pocket sized computer. The versatility of a smart phone has prompted its users to explore an increasing variety of applications developed by various vendors or independent developers, and thus a smart phone has developed several ways to obtain or download these applications or programs. Presently, the most common ways for a user to obtain software applications or programs would be to search or browse through various applications using a web browser or an independent browsing application. The independent browsing application could be for instance a market place browser or a store browser which are stand alone browsing applications.

Assuming that a user chooses to locate an application or a software program through a web browser, the user may first need to activate a web browser and then locate the application by performing a search operation through a search engine or by typing in a web address directly. After finding the correct website, the user may download the application hosted by a server through the website. Otherwise, assuming that a user chooses to locate an application through an independent browser such as a Market Place browser or a Store browser, the user may launch the independent browser through a home screen or a desktop of the smart phone by selecting the appropriate icons or shortcuts. After launching the independent browser, a user may search for targeted applications through means such as by performing a keyword search for the application or by browsing among applications sorted by user ratings or categories. When the targeted application has been found, the user may select the application for download, and then the smart phone would typically automatically download and install the application in an inconspicuous manner.

However, if a user would like to share an application by suggesting or recommending an application to someone else, application sharing might not be accomplished without difficulties as a mobile handheld electronic device would be limited by certain physical constraints imposed by necessary attributes such as lightness, slimness, shortness, and smallness. These physical constraints would mean that the size of a touch screen disposed on a portable device is constricted, and the number of keys and buttons disposed on a portable device thereon and sizes are also limited. Reduction of the screen size may limit batches of information capable of being displayed on the screen, and reduction of the number of the keys and the size thereof would increase difficulties of user inputs as a user may spend considerable time and effort struggling through small keys and a small touch screen in order to navigate among websites and search engines in order to locate an application.

Otherwise, if a user would prefer to locate an application through a Market Place program or a Store program, the user would first be required to learn about the application from a friend or from another resource, and then the user would be required to perform keyword searches or to utilize a browsing function of the program. Regardless whether a keyword search or a browsing is performed, the user would most likely have to sift through a voluminous quantity of very similar applications. Such endeavor is not only time consuming for the user, but also the user might not be certain whether any applications to be selected would be precisely the application which was originally intended or meant for in the first place. This means that if a user would like to suggest an application to another friend, there needs to be means for the user's friend to quickly and reliably locate the suggested application.

Therefore, at this present time, there could be a need for a method and a device to share a software application from one handheld mobile electronic device to another handheld mobile electronic device.

### SUMMARY OF THE DISCLOSURE

Accordingly, the present disclosure proposes a method of a method of sharing a software application from one handheld mobile electronic device to another handheld mobile electronic device and a handheld mobile electronic device using the same method.

In one of the exemplary embodiments, the proposed method and handheld mobile electronic device would include at least but not limited to a communication circuit for transmitting and receiving wireless data, a touch screen for receiving a touch input, and a processing circuit coupled to the communication circuit and the touch screen. The processing circuit is configured for displaying an image which corresponds to the application on the touch screen. After receiving the first touch input on the image, the touch screen displays a sharing area in response to a long hold action of a continuing the first touch input. The sharing area could be represented by a still image, an animated image, or an icon. When the continuing first touch action moves the image to the sharing area through the touch screen, the application which corresponds to the image would be shared through the communication circuit.

In one of the exemplary embodiments for the proposed method and handheld mobile electronic device, the processing circuit would be configured for sharing through the communication circuit the application in direct response to the release action of the first touch input. The processing circuit would obtain based on the application a code which is unique and specific for the application, and then the application would be shared through the communication circuit based on the code.

In one of the exemplary embodiments for the proposed method and handheld mobile electronic device, the processing circuit would be configured for detecting through the communication circuit at least one other handheld mobile electronic device nearby for direct communication. If the at least one other handheld mobile electronic device has been detected, the handheld mobile electronic device may share the application based on either a direct communication with the at least one other handheld mobile electronic device through the communication circuit, or the handheld mobile electronic device may share the application based on generating a quick response (QR) code image.

In one of the exemplary embodiments for the proposed method and handheld mobile electronic device, the processing circuit would be configured for generating a quick response (QR) code image based on the application specific code, and then sharing of the application would be accomplished through the communication circuit by transmitting the QR code image.

In one of the exemplary embodiments for the proposed method and handheld mobile electronic device, the processing circuit would be configured for sharing the application using the QR code image by displaying the QR code image on the touch screen. At least one other handheld mobile electronic device could then obtain the application by taking capturing the QR code image via a camera or a scanner.

In one of the exemplary embodiments for the proposed method and handheld mobile electronic device, the processing circuit would be configured for generating from the QR code image a hyperlink which includes a prefix and a suffix. The prefix is a partial web address which includes a domain name system (DNS) of a server. The suffix includes the application specific code which could be obtained from the QR code image. By constructing the hyperlink, the application could be shared by transmitting the hyperlink through the communication circuit so that another handheld mobile electronic device could download the application through the hyperlink.

In one of the exemplary embodiments for the proposed method and handheld mobile electronic device, the processing circuit would be configured for displaying through the touch screen first QR code image which includes a share option. In direct response to receiving a second touch input on the share option, the application could be shared via different ways through a list of menu. The handheld mobile electronic device may share an application through a text string such as a hyperlink or an image file.

In one of the exemplary embodiments for the proposed method and handheld mobile electronic device, in response to a second electronic device receiving the QR code image, the QR code image would be converted by the second electronic device into a hyperlink which corresponds to the application to be shared by the handheld mobile electronic device. The second electronic device may obtain the shared application from the handheld mobile electronic device by downloading the application through the hyperlink.

In one of the exemplary embodiments for the proposed method and handheld mobile electronic device, the processing circuit would be configured for detecting for at least one other electronic device through an electromagnetic wave (EM) transceiver. If at least one other electronic device has been detected, the handheld mobile electronic device may share an application via a direct wireless communication through the electromagnetic wave (EM) transceiver.

In one of the exemplary embodiments for the proposed method and handheld mobile electronic device, the processing circuit would be configured for establishing a direct connection through the EM transceiver. In direct response to the direct connection being established, the handheld mobile electronic device may share an application to another electronic device by directly transmitting the application specific code to the another electronic device which may then obtain the application using the application specific code.

In one of the exemplary embodiments for the proposed method and handheld mobile electronic device, the processing circuit would be configured for establishing a direct connection through the EM transceiver. In direct response to the direct connection being established, the handheld mobile electronic device may share an application to another electronic device by first converting the application specific code into a QR code image and then transmitting through the direct connection the QR code image directly to the second electronic device.

In one of the exemplary embodiments for the proposed method and handheld mobile electronic device, the EM wave transceiver would be a near field communication (NFC) transceiver.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A illustrates the hardware of a handheld mobile electronic device in terms of functional block diagrams in accordance with one of the exemplary embodiments of the present disclosure.

FIG. 1B illustrates a home screen user interface in accordance with one of the exemplary embodiments of the present disclosure.

FIG. 1C illustrates sharing an application through a touch screen interface in accordance with one of the exemplary embodiments of the present disclosure.

FIG. 1D illustrates sharing an application through a touch screen interface in accordance with one of the exemplary embodiments of the present disclosure.

FIG. 2 illustrates a method of sharing an application from one handheld mobile electronic device to another electronic device in accordance with one of the exemplary embodiments of the present disclosure.

FIG. 3 illustrates sharing an application from one handheld mobile electronic device to another electronic device in response to moving an image onto a share area in accordance with one of the exemplary embodiments of the present disclosure.

FIG. 4 illustrates sharing an application from one handheld mobile electronic device to another electronic device by generating a QR code in accordance with one of the exemplary embodiments of the present disclosure.

FIG. 5 illustrates establishing a direct connection between a handheld mobile electronic device and another electronic device in accordance with one of the exemplary embodiments of the present disclosure.

FIG. 6 illustrates sharing an application from one handheld mobile electronic device to a second electronic device through a direct connection from the perspective of the second electronic device in accordance with one of the exemplary embodiments of the present disclosure.

FIG. 7 illustrates sharing an application from one handheld mobile electronic device to a second electronic device from the perspective of the second electronic device receiving a hyperlink or a QR code image in accordance with one of the exemplary embodiments of the present disclosure.

FIG. 8A illustrates generating a hyperlink for application sharing in accordance with one of the exemplary embodiments of the present disclosure.

FIG. 8B illustrates the content of the hyperlink in accordance with one of the exemplary embodiments of the present disclosure.

### DETAILED DESCRIPTION OF DISCLOSED EMBODIMENTS

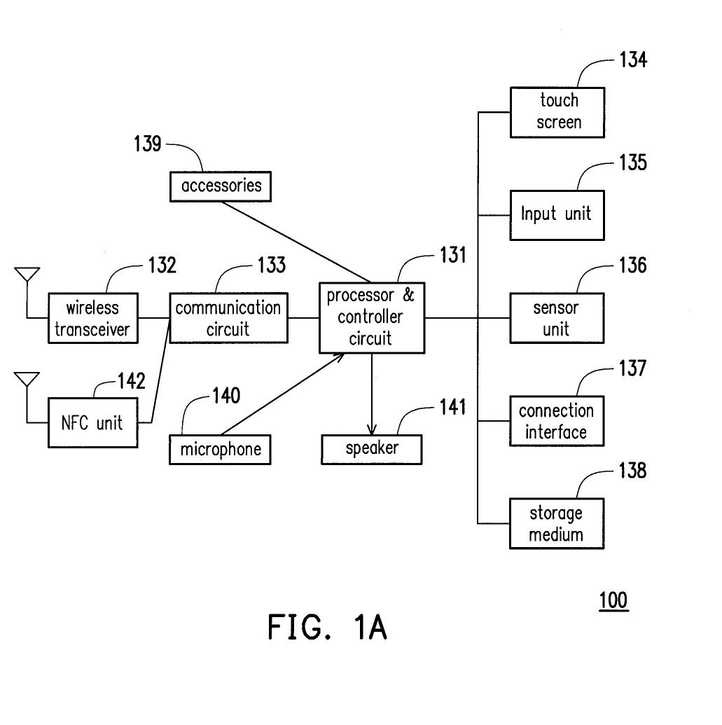

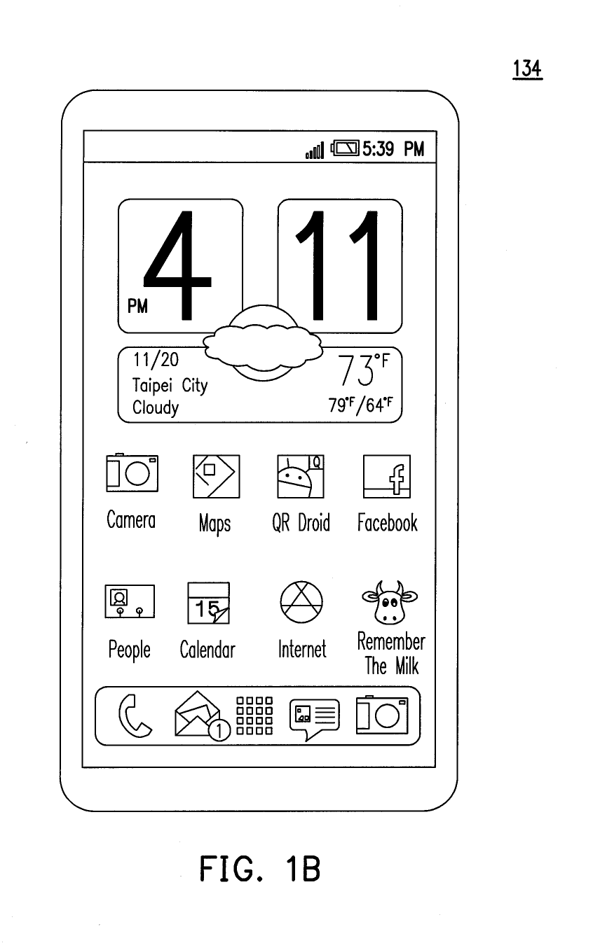

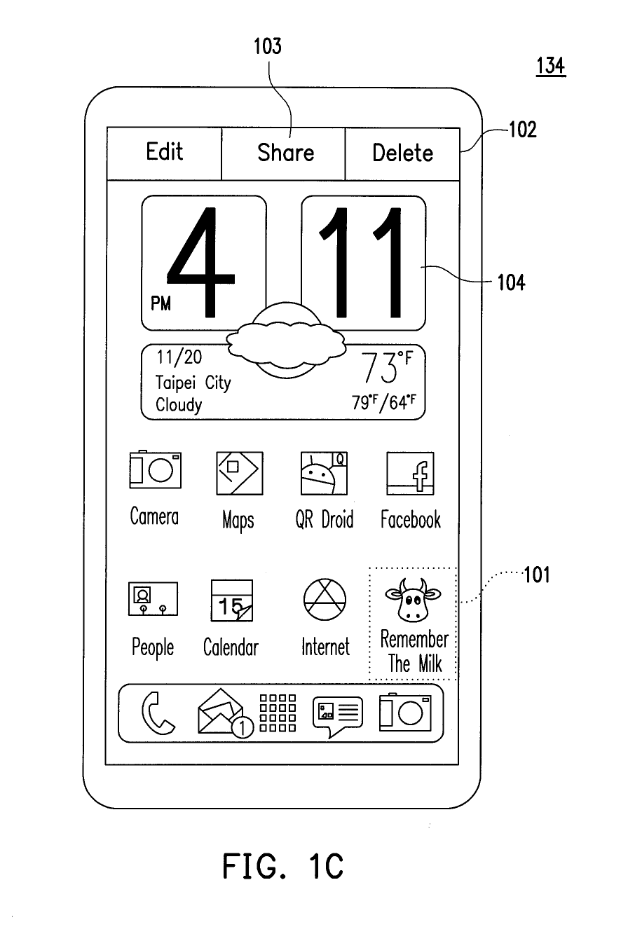

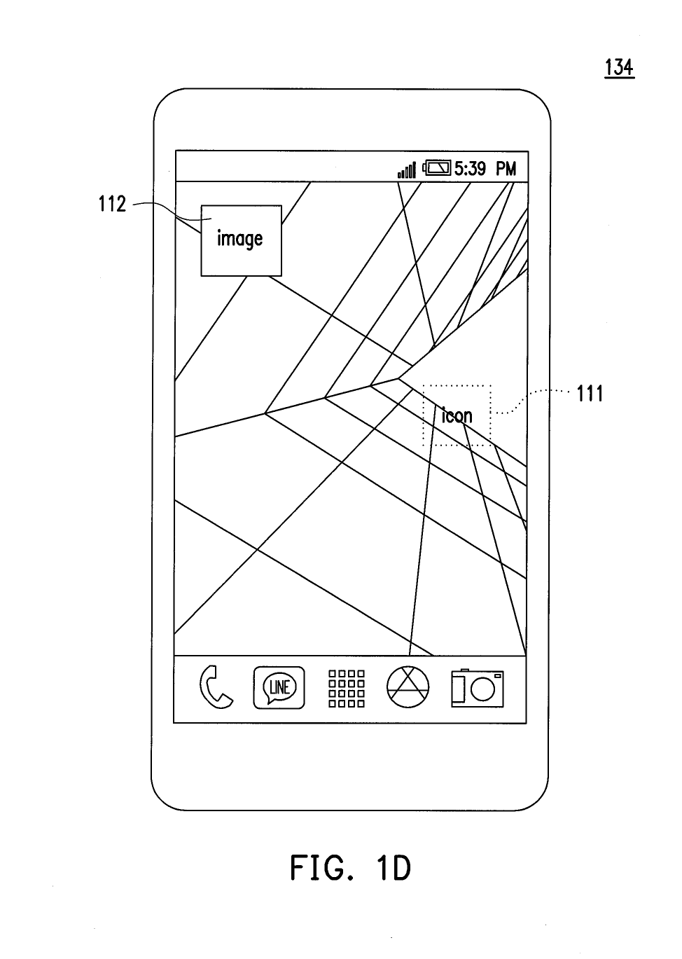

FIG. 1A illustrates the hardware of a handheld mobile electronic device in terms of functional block diagrams in accordance with one of the exemplary embodiments of the present disclosure. An exemplary mobile electronic device could be a smart phone, a mobile phone, a person digital assistant (PDA), a tablet, a notebook computer, and so forth.

The exemplary mobile electronic device 101 of FIG. 1A would include a processor and controller circuit 131. The processor and controller circuit 131 would be electrically coupled to at least but not limited to a wireless transceiver 132, communication circuit 133, a touch screen 134, an input unit 135, a sensor unit 136, a connection interface 137, a storage medium 138, accessories 139, and an audio controller interface which may include a speaker 141 and a microphone 140. The processor and controller circuit 131 may include a micro-controller, a North Bridge, a South Bridge, a field programmable array (FPGA), a programmable logic device (PLD), an application specific integrated circuit (ASIC), or other similar device, or a combination therefore. The processor and controller circuit 131 may also include a central processing unit (CPU) or a programmable general purpose or special purpose microprocessor, a digital signal processor (DSP), a graphics processing unit (GPU), an application specific integrated circuit (ASIC), a programmable logic device (PLD), or other similar device or a combination thereof, which is used for processing all tasks of the exemplary mobile electronic device 101 for executing functions related to the proposed method of the present disclosure.

The communication circuit 133 could be one or more components which support signal transmissions of a global system for mobile communication (GSM), a personal handy-phone system (PHS), a code division multiple access (CDMA) system, a wireless fidelity (Wi-Fi) system or a worldwide interoperability for microwave access (WiMAX). The communication circuit 133 could be integrated with the processor & controller circuit 131 to form a single unit or could be an independently configured unit.

The communication circuit 133 could be coupled to a wireless transceiver unit 132 to provide wireless access for the mobile electronic device 101. The wireless transceiver unit 132 may include but not limited to a transmitter circuit, a receiver circuit, an analog-to-digital (A/D) converter, a digital-to-analog (D/A) converter, a low noise amplifier (LNA), mixers, filters, matching networks, transmission lines, a power amplifier (PA), one or more antenna units, and a local storage medium. The transmitter and the receiver transmit downlink signals and receive uplink signals wirelessly. The receiver may include functional elements to perform operations such as low noise amplifying, impedance matching, frequency mixing, down frequency conversion, filtering, amplifying, and so forth. The transmitter may include function elements to perform operations such as amplifying, impedance matching, frequency mixing, up frequency conversion, filtering, power amplifying, and so forth. The analog-to-digital (A/D) or the digital-to-analog (D/A) converter is configured to convert from an analog signal format to a digital signal format during uplink signal processing and from a digital signal format to an analog signal format during downlink signal processing.

The touch screen 134 may contain a display such as a liquid crystal display (LCD), a light-emitting diode (LED) display, a field emission display (FED) or other types of display. The input unit 135 could be, for example, an input device such as a mouse, a keyboard, a joystick, a wheel, and so forth and would receive an input operation from a user. The input unit 135 may also include a resistive, a capacitive or other types of touch sensing device which would be integrated as a part of the touch screen 134.

The sensor unit 136 may contain various sensors such as a G-sensor, a gyroscope, a motion sensor, a proximity sensor, and so forth.

The connection interface 137 could be, for example, a cable interface such as a universal serial bus (USB) or a wireless interface such as Bluetooth. The connection interface 137 could be a serial interface such as RS232 interface or could be a parallel interface such as USB or Firewire.

The storage medium 138 could volatile or permanent memories which would store buffered or permanent data such as compiled programming codes used to execute functions of the exemplary mobile electronic device 101.

The exemplary mobile electronic device 101 may further include a short range transceiver for a direct communication with another electronic device. The short range transceiver could be for instance a near field communication (NFC) unit 142 which could be coupled to the communication circuit 133 or to the processor & controller circuit 131. The near field communication unit 142 could be configured to communicate across the air interface with another wireless transceiver based on a standardized transport protocol such as ISO/IEC 18092/ECMA-340 or ISO/IEC 21481/ECMA-352.

Currently, one of the most common methods of sharing an application from a first handheld mobile electronic device to a second electronic device may requires the second electronic device to perform a search using an application browser. By doing so, the search may actually produce a voluminous number of very similar applications which would hinder the search of the correct application as originally intended. Otherwise, either one of the first and the second electronic devices may be required to find the exact link through a search engine in order to suggest or to download the application. Such process could be problematic as it would be tedious as well as time consuming. The problem could even be compounded by the size limitation of a handheld mobile electronic device such that a user would have to struggle through the operation of the small interface of a handheld mobile electronic device before finding the right application. Therefore, a method of sharing an application from one mobile handheld electronic device to another electronic device is proposed.

The proposed method of the present disclosure may include sharing an application which is represented by an icon or an image or a shortcut through a touch screen in which icons or images or shortcuts would be displayed. Even though the present disclosure demonstrates sharing of an application through a page of a home screen, an application could in fact by shared through any screen and as long as the screen displays an icon or an image or a shortcut of an application to be shared.

FIG. 1B illustrates a page of a home screen user interface before a user chooses an application to be shared. FIG. 1B is currently well known in the art as the touch screen 134 may display a page of the home screen to include a top panel for displaying system information in the top most location of the touch screen 134, a widget for showing the date, the time, and the weather information, a plurality of icons or shortcuts, and a shortcut panel on the bottom.

FIG. 1C illustrates sharing an application through a touch screen interface in accordance with one of the exemplary embodiments of the present disclosure. Referring FIG. 1B and FIG. 1C together, it is assumed that a hypothetical software program named “Remember the Milk” is to be shared to another electronic device. The hypothetical software program could be any application which could be found in a market place server, a store server, or a third party server and has a unique application specific identification (ID) per operating system. The icon 101 would be a representative image and a shortcut for the hypothetical software program. Before the icon 101 is operated on, the touch screen 134 could display an image as shown in FIG. 1B. After a long hold touch action of a first touch input has been received by the input unit 135 through the touch screen 134, the top most display panel of FIG. 1B could be replaced by an icon management menu 102 of FIG. 1C. In other words, the icon management menu 102 would be exposed in direct response to a touch and long hold action on the icon 101 or actually any icon displayed by the touch screen 134. The icon 101 could then be shared by subsequently moving the icon 101 to be at least partially within the share area 103 of the icon management menu 102 as a continuation of the long hold action of the first touch input. When the icon 101 is within the share area 103, an application sharing mechanism would be initiated.

In one exemplary embodiment, the sharing of the icon 101 to another electronic device could be triggered if at least half of the icon is within the share area 103. If the icon 101 could not finish moving to the share area 103 and the touch input on the icon 101 has been released, the icon management menu 102 may be reverted back to the system information display panel of FIG. 1B, and consequently a long hold action on an icon to be shared has to be initiated in order to re-expose the icon management menu 102. Also it should be noted that sharing an application means that an application is suggested or recommended to another electronic device by transmitting to the another electronic device pertinent information such as a code, a text, or an image file so that the recommended application could be obtained by the another electronic device. The pertinent information could be transmitted through a radio access network (RAN) to another electronic device, or through TCP/IP via a private or public network, or transmitted directly through a medium range transceiver such as Bluetooth or Wifi or through a short range transceiver such as a NFC transceiver.

FIG. 1D illustrates another embodiment of sharing an application through a touch screen interface in accordance with one of the exemplary embodiments of the present disclosure. For the embodiment of FIG. 1D, the touch screen 134 displays another interface which could be for example another page of the home screen. Assuming that an application represented by the icon 111 is to be shared to another electronic device, and a second image may represent a second sharing area 112. The icon 111 could be shared by moving the icon 111 to the second sharing area 112. In one exemplary embodiment, the second sharing area 112 may represent a second medium of sharing.

For example, when an icon is at least partially overlapping the second sharing area 112, a mechanism for a direct wireless sharing could be activated while the sharing area 103 would be for non-direct wireless sharing such as through a wireless or cabled network. In another exemplary embodiment, both the sharing area 103 and the area represented by the second sharing area 112 could be considered for both direct and non-direct sharing, and specific details would be disclosed later on. In one exemplary embodiment, the second sharing area 112 could be a specific application represented by an icon or an image or a shortcut. In another exemplary embodiment, the second sharing area 112 is an area of within the wall paper and would appear into existence in response to a long hold action on the icon 111.

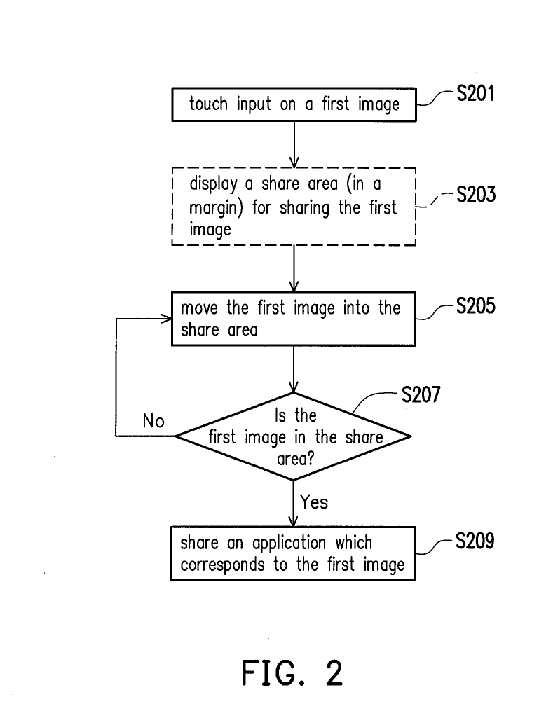

FIG. 2 a flow chart which illustrates the method of sharing an application from one handheld mobile electronic device to another electronic device in accordance with one of the exemplary embodiments of the present disclosure. In step S201, a touch input on a first image would be received by a touch screen. In step S203, an application sharing area would appear in a margin of the touch screen as a consequence to a long hold action of the touch input. In step S205, the first image would be moved to the sharing area. In step S207, whether the first image is moved to the sharing area would be determined. If the first image has been moved to the sharing area, step S209 would be executed, and subsequently the handheld mobile electronic device would initiate an application sharing mechanism to share the application represented by the first image. If the first image has not been moved to the sharing area, the process would gravitate back to step S205 and may terminate if the touch input has been released.

For the following example, FIG. 1C and FIG. 2 would be referred together. In step S201, a touch input on an icon 101 which could be a representative icon of an application or a representative shortcut to an application has been detected by the touch screen 134. In step S203, a system information display panel on top of FIG. 1B could be replaced by an icon management menu 102 in response to a long hold action which continues from the touch input. The threshold of the long hold could be, for example, one second as the icon management menu 102 may appear after one second. In step S205, the icon 101 would be moved to a sharing area 103 in order to share the application represented by the icon 101. In step S207, whether the icon 101 is at least partially overlapping with the sharing area 103 would be determined. If the icon would be at least half overlapping with the sharing area 103 or partially overlapping with the sharing area 103 for a predefined duration such as 0.5 second, step S209 would be executed. Otherwise, the procedure moves back to step S205 until the touch input has been released. In step S209, an application sharing mechanism would be initiated.

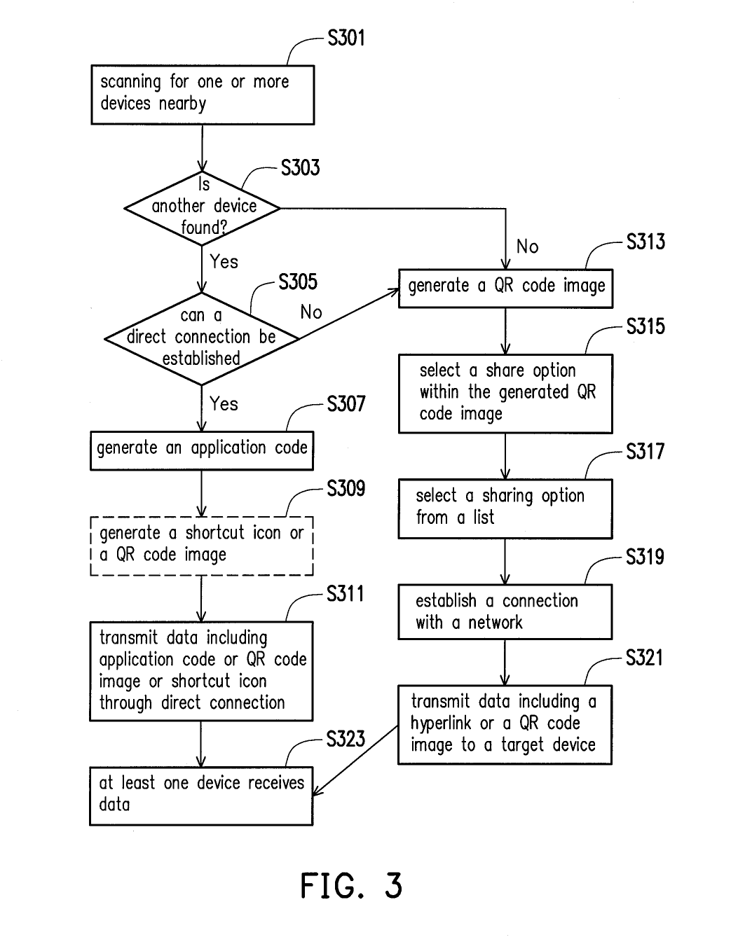

FIG. 3 illustrates sharing an application from one handheld mobile electronic device to another electronic device in response to moving an image onto a share area in accordance with one of the exemplary embodiments of the present disclosure. FIG. 3 illustrates exemplary implementation of the step S209 of FIG. 2. For this exemplary implementation of the application sharing mechanism, the handheld mobile electronic device may first scan for at least one or more devices nearby using a scanner. The scanner could be a microwave scanner which detects the presence of other devices as well as identifying the identity of other devices by scanning the RFIDs of other devices. If at least one other device has been found by the scanner, the handheld mobile electronic device may initiate a direct data communication sequence using a short range microwave communication device such as the NFC circuit in order to share an application with a detected device.

It should be noted that more than one device could in fact be located by using a microwave scanner. If a device falls outside the beam width of the microwave scanner, a user may move the handheld mobile electronic device until other devices are located. Direct communication here means a direct communication could be established between two devices through a free spectrum without requiring a base station, a hub, or a repeater to relay information in between. If a direct short range communication could not be established using NFC or if an application sharing target is not nearby or could not be detected, the handheld mobile electronic device may share the application indirectly through a RAN or a cabled network or through other direct medium or long range communications such as Bluetooth or Wifi.

In one exemplary embodiment, a user may determine whether to share an application directly or indirectly by using different sharing areas (e.g. 103 112) with one configured for direct communication and the other configured for indirect communication. In another exemplary embodiment, a user may rely on the handheld mobile electronic device to automatically determine the mode communication in order to share an application. FIG. 3 would illustrate the latter embodiment.

In step S301, a handheld mobile electronic device would scan for one or more suitable targets nearby. Assuming that a user wants to share an application to one or more friends' mobile phone nearby, in step S303, if at least one other device has been detected nearby, step S305 would be executed as the handheld mobile electronic device would utilize a direct connection to share an application. Otherwise, step S313 would be executed, and the mobile electronic device would share an application through a wireless network, the internet, or through Bluetooth or Wifi. In step S315, the handheld mobile electronic device would determine whether a direct NFC connection could be established by initiating a handshaking operation with at least one other electronic device nearby. If a direct connection can be established, step S307 would be executed; otherwise step S313 would be executed.

In step S307, the handheld mobile electronic device would obtain an application specific code for the application to be shared. The application specific code could be obtained by looking up the metadata of each application currently installed. The application specific code would be inherent for each application and would be accessible for the operating system of each handheld mobile electronic device. Next, step S311 could be executed by transmitting the application specific code directly through the established direct connection, and the target device which receives the code on the other end could know the exactly application to be shared based on the application specific code. Otherwise, the handheld mobile electronic device may execute step S309 and generate a shortcut icon or a QR code image which corresponds to the application to be shared beforehand and transmit the shortcut icon or the QR code image through the direct connection in step S311. In step S323, target(s) nearby would receive the data transmitted from the handheld mobile electronic device and would know the application to be shared from the data transmitted.

In one of the exemplary embodiments, the application specific code could be shared by engraving the application specific code in a rewritable RFID memory tag. For this embodiment, after a representative icon of an application has been moved to a sharing area in response to a long hold operation, the application specific code would be written in the RFID memory tag of the NFC unit 142. The application specific code could then be obtained when another electronic device nearby scan the rewritable RFID memory tag. The application specific code would then be converted into a hyperlink, and another device which received the hyperlink could then download the shared application through a website.

If after a representative icon of an application has been moved to a sharing area in response to a long hold operation but in step S303 or S305 a target electronic device is not nearby or a direct connection with the target electronic device could not be established, in step S313, the handheld mobile electronic device could share an application by generating a QR code image from the application specific code. A QR code image could be generated using an open source program or a proprietary application, and conversions between an application specific code and a QR code image currently is well known in the art. The QR code image in accordance with the present disclosure would further include a share option associated with the QR code image. One advantage of the QR code image is that one device in proximity may have the option of scanning the QR code image using one's camera or scanner. After scanning the QR code image with one's camera, the electronic device performing the scan may obtain the application specific code and may then construct a hyperlink based on the application specific code.

Otherwise, a handheld mobile electronic device may share an application to another electronic device by activating a share option of the QR code image. When the share option is activated by a touch signal in step S315, the touch signal on the share option would trigger a menu list to appear. The menu list would include a list of different means to share an application. The list of menu may include means such as Bluetooth, Dropbox, Facebook, Flicker, email, Text messages, Instant messages, Social Network, and so forth. In step S317, one item from the menu list would be selected. For example, if Bluetooth is selected, the communication circuit 133 could activate a Bluetooth module to transfer the QR code image directly to a target device. If Dropbox or Flicker is selected, the QR code image could be transferred over to servers through their website interfaces respectively. If any of email, text messages, or instance messages is selected, a hyperlink would be automatically generated and posted in these programs. The exact generation of the hyperlink would be described later on.

For example, if a social network such as Facebook has been selected, list of candidate recipients could then appear. The operator of the handheld mobile electronic device may then select a friend from a contact list to receive the hyperlink, which would then be posted on the wall of the friend who has been selected. If an email such as Gmail or Hotmail has been selected, the operator could post hyperlinks in an email to be sent to a recipient. A similar principle of operation would apply to an instant message program such as Line or App from which a user may select a friend from a contact list and post the hyperlink in the message space of the friend. When the hyperlink is received by a target electronic device and seen by the operator of the target electronic device through a browser, the operator of the target electronic device may activate the hyperlink. Through the hyperlink, the operator of the target electronic device would be able to access a website of the shared application. The operator of the target electronic device may then download the application from the website of a server which hosts the application to be shared.

In step S319, after a sharing option has been selected from a menu list, the mobile handheld electronic device would establish a connection with a network. Through the connection with the network, data including a QR code image of the application to be shared or a hyperlink to be posted would be transferred over to a target electronic device to receive the application to be shared. The network may include the Internet, an intranet, a radio access network, or a local wireless network such as Bluetooth or Wifi. In step S321, the mobile handheld electronic device would transmit data which include the hyperlink or the QR code image to the target electronic device through the connection to the network. In step S323, the data would be received by the target electronic device, and the application to be shared could be downloaded by the target electronic device.

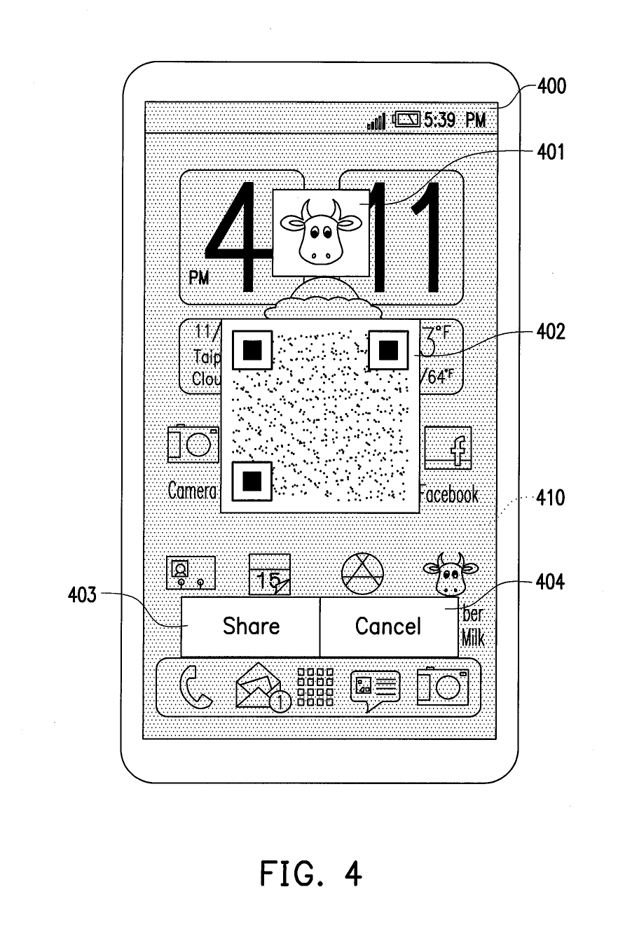

FIG. 4 illustrates sharing an application from one handheld mobile electronic device to another electronic device by generating a QR code in accordance with one of the exemplary embodiments of the present disclosure. In FIG. 4 the touch screen 400 may show a semi-transparent QR code image 410 which includes a representative image 401 or a thumbnail of the application to be shared. The semi-transparent QR code image 410 may overlay the previous screen and shows the user interface underneath. The QR code image may appear after steps S201˜S209 of FIG. 2 has been performed. The application to be shared in FIG. 4 is assumed to be the same as the application to be shared of FIG. 1C. The QR code image 410 may include an QR code pattern 402 for the application, a share option 403, and a cancel option 404. Underneath the semi-transparent QR code image 410 for this particular example is the same interface as FIG. 1B.

The embodiment of FIG. 4 would be briefly described in conjunction with FIG. 3. In step S313, the QR code image for the icon 101 which represents the application “Remembering the Milking” would be generated. In step S315, the operator of the handheld electronic device select through the touch screen 134 the share option 403 to bring up a list of menu through which different means of sharing the QR code image 410 could be selected. Assuming that a user selects Flicker from which the QR code image could be obtained by a friend directly, steps S317˜S323 would then be executed so that the QR code image would be obtained by the friend who operates another electronic device. The friend could then use a QR code image reader which would read the QR code image 410 and automatically construct a hyperlink. The friend who receives the QR code image 410 would then be taken to a website of the hyperlink in order to download the application assuming that the friend would choose to download the application. It has been noted that when the QR code image 410 is generated in step S313, if another electronic device is nearby, the electronic device could capture the QR code image directly with a scanner or a camera. The application which corresponds to the QR code image 410 could then be downloaded after a QR code image reader is used to convert the QR code image 410 into a corresponding hyperlink.

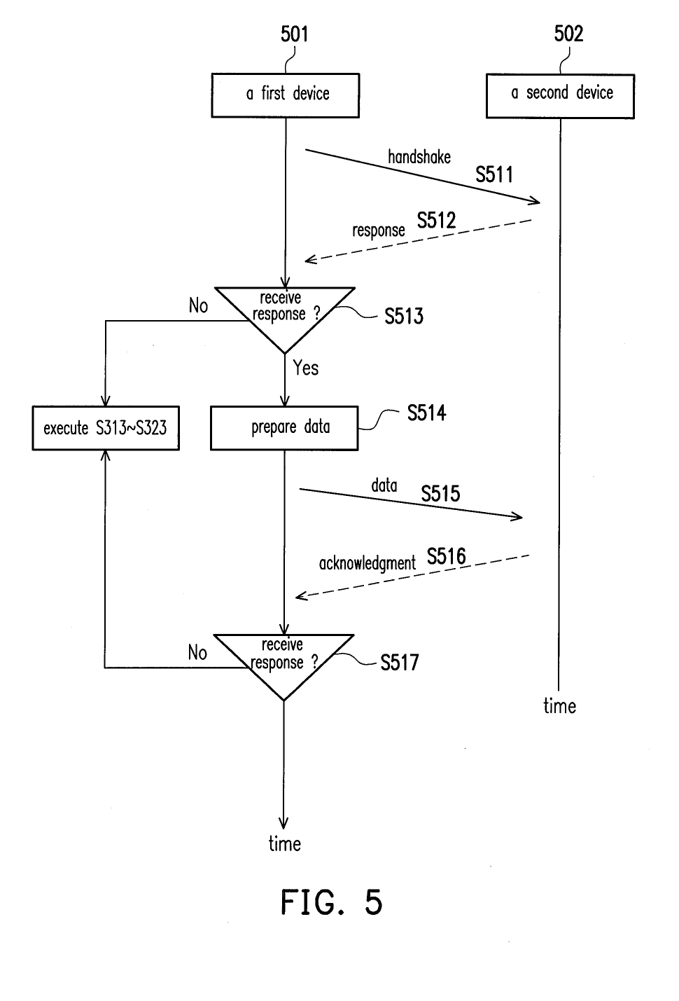

FIG. 5 illustrates establishing a direct connection between a handheld mobile electronic device and another electronic device in accordance with one of the exemplary embodiments of the present disclosure. It is assumed that in FIG. 5, a short range microwave transceiver such as a NFC circuit is used to implement direct communication between a first handheld mobile electronic device 501 and a second electronic device 502, and the second device 502 has been located by the first device 501 which has performed a scan. It should be noted that the direct communication method of FIG. 5 is merely exemplary as the present disclosure is not limited by the exact method of FIG. 5 as FIG. 5 may omit steps which are not pertinent to the present disclosure. The communication method could be implemented by the first device 501 to communicate with a plurality of devices within the range of its transceiver.

In step S511, the first device 501 transmit a handshake signal to the second device 502 to request for a connection with the second device 502. In step S512, the first device may receive a response S512 such that the first device 501 may know that a direct connection is feasible with the second device 502 and at the same time synchronization could be achieved between the first device 501 and the second device 502. In step S513, the first device 501 determines whether a response (e.g. the response in S512) from the second device has been received within a predetermined period which could be set for 1 second or greater. If a response has not been received within the predetermined period, steps S313˜S323 would then be executed instead as these steps do not require a direct connection. This could mean that a direct communication would not be feasible at this point in time. If a response has been received, then in step S514, the first device 501 would prepare the data to be transferred over to the second device 502. In step S515, the first device may transmit data to the second device 502, and also in step S516, the first device 501 may receive acknowledgements from the second device 502 for the data received. It should be noted that steps S511, S512, S515, and S516 could be based on a standard NFC protocol or a non-standard protocol. In step S517, if an acknowledgment has not been received as expected within a predetermined period for whatever reason such as the operator of the second device 502 walks away from the first device 501, the direct communication would be aborted and hence steps S313˜S323 would then be executed.

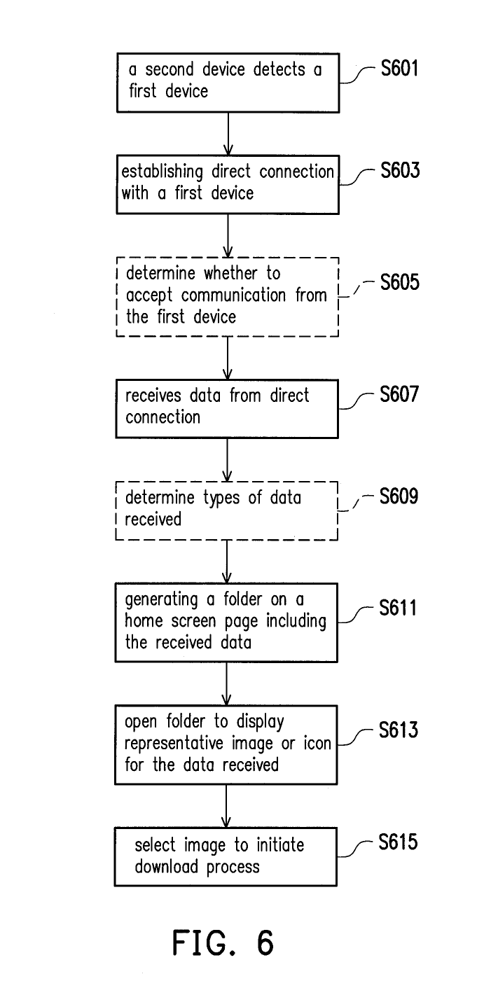

FIG. 6 illustrates sharing an application from one handheld mobile electronic device to a second electronic device through a direct connection from the perspective of the second electronic device in accordance with one of the exemplary embodiments of the present disclosure. In step S601, a second device, or a target device, has been scanned and detected by a first device which shares an application to the target device. In step S603, a direct communication has been established between the first device and the second device. In step S605, a second device may be required to accept whether to communication with the first device for security purpose in order to make sure that the second device does not receive data from an unfriendly device. In step S607, assuming that the second device accepts the direct communication from the first device, the second device would receive through the direct connection transmitted data which may include one of a QR code image, a shortcut icon, or an application specific code.

In step S609, the second device would determine the type of data received and in step S611 generating a folder on a page of a home screen so that the received data could be located. For example, if an application specific code has been received through NFC communication, the second device could automatically convert from the application specific code into a shortcut icon which contains a generated hyperlink from the specific code and by placed the shortcut icon in the folder. In another embodiment, the second device could convert from the application specific code received through the NFC connection into a thumbnail of QR code image and place the QR code image into the folder for browsing purposes. If a QR code image or a shortcut icon containing a hyperlink has been received in step S609 instead, the QR code image or the shortcut icon would also be placed in the folder. In step S613, the folder could be activated to browse the received data in the form of a QR code image or a representative shortcut icon. In step S615, a user may apply a QR code image reader which would automatically convert a QR code image into an application specific code, construct a hyperlink based on the application specific code, and activate a web browser to display the website pointed to by the hyperlink. The user may then choose whether to download the shared application from the website. Otherwise in step S615 a user may select a representative shortcut image in the folder, a hyperlink would be automatically extracted from the shortcut image, and a web browser would be automatically activated to display the website pointed to by the hyperlink.

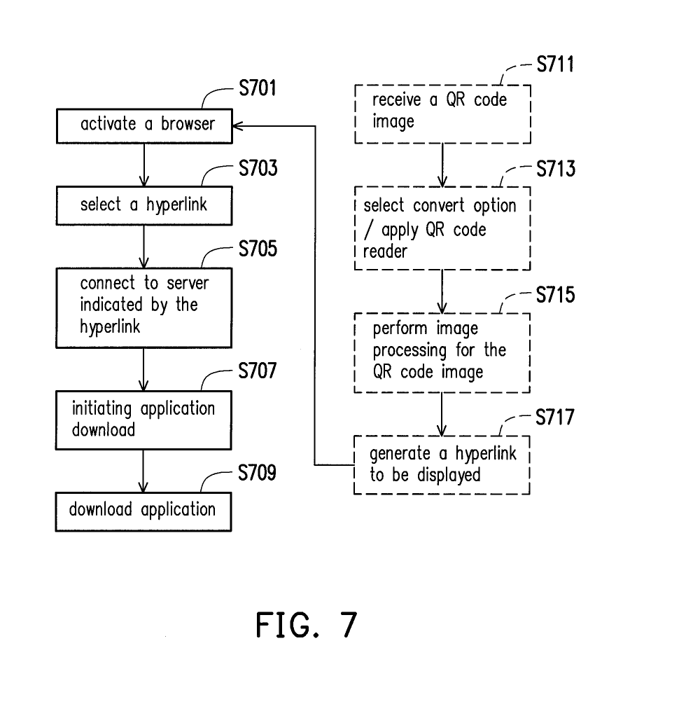

FIG. 7 illustrates sharing an application from a first handheld mobile electronic device to a second electronic device from the perspective of the second electronic device receiving a hyperlink or a QR code image in accordance with one of the exemplary embodiments of the present disclosure. For the scenario of FIG. 7, it is assumed that a direct connection using NFC is not used and steps S313˜S323 have been performed. In step S711, the second electronic device receives a QR code image. In step S713, a QR code image reader has been activated to decode the QR code image.

In another exemplary embodiment, a QR code image would contain a convert option from which the option may be selected to automatically activate a reader. In step S715, image processing is performed by the QR code image reader to extract the application specific code embedded in the QR code image. In step S717, a hyperlink is generated from the application specific code to be displayed in a browser.

In step S701 a browser is activated to display the hyperlink. Steps S711 S717 would be unnecessary if in step S317, the selected sharing option is not to share an application by transmitting a QR code image using Dropbox or Flicker but to share an application by posting the generated hyperlink in an email, social network, text message, or instant message. In step S703, the hyperlink displayed by the browser could be selected and activated. In step S705, the second electronic device would connect to a server which hosts the website containing a link to download the application shared from the first electronic device, and the browser would display the contents of the website. In step S707, the second electronic device may determine whether to download the application through the website and log into the server to initiate the download process. In step S709, the second electronic device may download the application shared from the first electronic device once the operator of the second electronic device has decided to download the application.

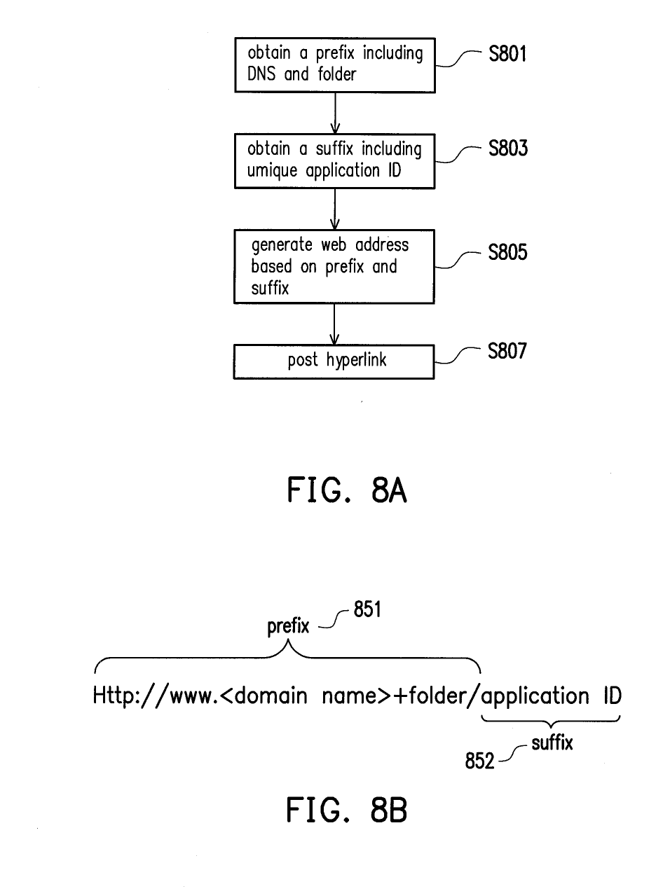

FIG. 8A illustrates generating a hyperlink from an application specific code for application sharing in accordance with one of the exemplary embodiments of the present disclosure. A hyperlink could be generated from an application specific code by applying a prefix in conjunction with a suffix. The prefix would be a partial web address include a domain name system (DNS) of a server with a folder in which information might be stored in the server. The prefix would typically be fixed and known in advance and thus would automatically be used when constructing any hyperlink. The name of the folder would be follow the DNS with a back slash. The suffix would be the actual application specific code. Therefore, the whole hyperlink would be a web address which indicates the place where the application to be shared is located and the application specific code which identifies the application stored in the server. Referring to FIG. 8, in step S801, an electronic device which generates the hyperlink obtains a prefix which includes at least but not limited to a DNS and a name of a folder in which the application is stored. In step S803, the electronic device obtains a suffix which includes at least but not limited to the unique application identification or the application specific code of an application to be shared from one electronic device to another electronic device. In step S805, the hyperlink would be generated by attaching the prefix with the suffix. In step S807, the hyperlink would eventually be posted in an email or a message after it is constructed. Any target device may then activate the hyperlink to download a shared application from the application website.

FIG. 8B illustrates the content of the hyperlink in accordance with one of the exemplary embodiments of the present disclosure. The prefix 851 of the hyperlink may include a DNS followed by a backslash which is followed by a folder name with a backslash. The exemplary suffix 852 would include an application specific code or an application ID.

In view of the aforementioned descriptions, the present disclosure proposes a fast, easy, and intuitive way of sharing an application from one mobile handheld electronic device to another electronic device. By operating a user interface to move a representative icon to a sharing area, it would be fast and easy for an operator to share any application. The present disclosure allows an operator to choose from a variety of different options to share an application as well as choosing the transport based on the proximity of a target device. The present disclosure may also allow for an automatic selection of a transport through proximity detection and connection establishment with a target device. Furthermore, by sharing an application through an application specific code, a hyperlink, or a QR code image, the actual data transmitted from one mobile handheld electronic device to another electronic device would be quite minimal and would require less bandwidth than transmitting an application or an installer of the application between devices.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

In all the drawings of the present disclosure, a box enclosed by dotted lines would mean an optional functional element or an optional step, and a dotted line may mean that the process flow could be optional or may not necessarily occur.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method of sharing an application, adapted for a handheld electronic device having a touch screen, and the method comprises:
displaying an image which corresponds to the application on the touch screen;
receiving a first touch input on the image;
displaying a sharing area of the touch screen in response to a long hold of the first touch input;
moving the image to the sharing area according to a moving action of the first touch input; and
sharing the application in response to a release action of the first touch input.

2. The method of claim 1, wherein the step of sharing the application which corresponds to the first image when the first image is moved to the sharing area comprises:
obtaining a first code which is unique and specific for the application; and
sharing the application based on the first code.

3. The method of claim 2, wherein the step of sharing the application to the second electronic device based on the first code comprises:
generating a first quick response (QR) code image based on the first code; and
sharing the application using the first QR code image.

4. The method of claim 3 further comprising:
sharing the application using the first QR code image by displaying the first QR code image on the touch screen.

5. The method of claim 3, wherein the step of sharing the application using the first QR code image comprises:
generating from the application a first hyperlink which comprises a prefix and a suffix, wherein the prefix comprises a partial web address, and the suffix comprises the first code; and
transmitting the first hyperlink to share the application.

6. The method of claim 3, wherein the step of sharing the application using the first QR code image comprises:
displaying a share option of the first QR code image;
receiving a second touch input on the share option; and
selecting a sharing mean when receiving the second touch input on the share option, wherein the sharing mean comprises a web address or an image file.

7. The method of claim 3 further comprising:
receiving the first QR code image by a second electronic device;
converting the first QR code image into a second hyperlink which corresponds to the application by the second electronic device; and
downloading the application by the second electronic device through the second hyperlink.

8. The method of claim 2, wherein the step of sharing the application based on the first code comprises:
detecting a third electronic device nearby wirelessly; and
establishing a direct connection with the third electronic device when the second electronic device is detected.

9. The method of claim 8 further comprising:
converting the first code into a second QR code image; and
transmitting the second image to the third electronic device through the direct connection.

10. The method of claim 8 further comprising:
transmitting the first code to the third electronic device through the direct connection; and
the third electronic device generating a third QR code image in response to receiving a third code;
the second electronic device generating a third hyperlink from the third QR code image; and
the second electronic device downloading the application from the third hyperlink.

11. A handheld electronic device comprising:
a communication circuit for transmitting and receiving data;
a touch screen for receiving a first input; and
a processing circuit coupled to the communication circuit and the touch screen and is configured for displaying an image which corresponds to the application on the touch screen, receiving the first touch input on the image, displaying on the touch screen a sharing area in response to a long hold of the first touch input, moving the image to the sharing area through the touch screen according to a moving action of the first touch input, and sharing through the communication circuit the application in response to a release action of the first touch input.

12. The device of claim 11, wherein the processing circuit is configured for sharing through the communication circuit the application in response to the release action of the first touch input comprises:
obtaining a first code which is unique and specific for the application; and
sharing through the communication circuit the application based on the first code.

13. The device of claim 12, wherein the processing circuit is configured for sharing through the communication circuit the application based on the first code comprises:
generating a first quick response (QR) code image based on the first code; and
sharing through the communication circuit the application using the first QR code image.

14. The device of claim 13 wherein the processing circuit is configured for sharing through the communication circuit the application using the first QR code image comprising:
Sharing the application using the first QR code image by displaying the first QR code image on the touch screen.

15. The device of claim 13 wherein the processing circuit is configured for sharing through the communication circuit the application using the first QR code image comprising:
generating from the application a first hyperlink which comprises a prefix and a suffix, wherein the prefix comprises a partial web address, and the suffix comprises the first code; and
transmitting through the communication circuit the first hyperlink to share the application.

16. The device of claim 13 wherein the processing circuit is configured for sharing through the communication circuit the application using the first QR code image comprising:
displaying through the touch screen a share option of the first QR code image;
receiving through the touch screen a second touch input on the share option; and
selecting a sharing mean when receiving the second touch input on the share option, wherein the sharing mean comprises a web address or an image file.

17. The device of claim 12, wherein the device further comprising:
a direct electromagnetic wave (EM) transceiver coupled to the communication circuit for detecting a second electronic device; and
establishing a direct connection through the direct EM transceiver with the second electronic device when the second electronic device is detected.

18. The device of claim 17 wherein the processing circuit is further configured for:
converting the first code into a second QR code image; and
transmitting through the communication circuit the second QR code image to the second electronic device through the direct connection.

19. The device of claim 17 wherein the processing circuit is further configured for:
transmitting through the communication circuit the first code to the second electronic device through the direct connection.

20. The device of claim 17, wherein the direct EM wave transceiver is a near field communication (NFC) device.
